(19) United States
(12) Patent Application Publication
(10) Pub. No.: US 2003/0073460 A1
(43) Pub. Date: Apr. 17, 2003

(54) Modular headset for cellphone or MP3 player

(75) Inventors: Engelbert van Pelt, Mountain View, CA (US); Jonathan Griffiths, Fremont, CA (US)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 09/981,190

(22) Filed: Oct. 16, 2001

(51) Int. Cl. H04M 1/00

(52) U.S. Cl. 455/556; 455/568

(57) ABSTRACT

A modular headset comprises a first unit that has first and second operational modes. In the first operational mode, the unit has a stand-alone functionality and serves as a wireless earpiece of a mobile phone. To this end, the first unit has Bluetooth processing means onboard. In the second mode, the first unit is connected to a second unit, the latter being an earpiece for the other ear. The second unit has processing power onboard for generating stereo audio when coupled with an MP3 player. Resources of the second unit are shared with the first unit in the second operational mode.

### FIELD OF THE INVENTION

The invention relates to an audio device with a headset unit, and to a headset unit.

### BACKGROUND ART

A headset, also referred to as “headphone”, is used to listen to audio produced by a wide variety of electronic audio devices. Examples of such devices that are used with a headset are a broadcast radio receiver, a CD Player, an MP3 player, two way radio, mobile phone and television receiver.

A headset can be connected to the audio device by a cable or wirelessly. Wireless connections can be used to free the user from being tied directly to the audio device by a cable. In the case of a wireless connection the audio signal is encoded or modulated directly onto the radio carrier signal. Suitable wireless technologies may include radio (RF) connectivity such as Bluetooth, DECT, or 802.11b, or another technology such as communication via infra red (IR).

A headset includes an audio transducer for being worn close to the ear. In case the headset provides audio for both ears, the headset has a pair of transducers, one for each ear. The headset also includes any additional electronics required to connect the headset to the audio device the user wishes to listen to, and optionally, additional user interface (UI) features such as a volume control. In case of a wireless headset, a battery, a solar cell or another power source is required to power the headset.

The type of headset required typically depends on the application. A mono headset with limited frequency reproduction range may be most suited to listening to a mobile phone for example. On the other hand, a stereo headset with a wider frequency range would be much better suited when listening to a higher quality audio source, such as a CD player, an MP3 player or a radio broadcast.

Various headset and headphone designs are available, including wireless Bluetooth headsets designed for cable-free connection to a mobile phone. Such cable-free designs allow private, hands free operation, and are well suited for operation in noisy environments. Many types of headsets are available for alternative high quality (stereo audio) applications, including wireless designs.

### SUMMARY OF THE INVENTION

Known headset design and capability are typically categorized by application. For example, a mobile phone may be used with a mono headphone or headset. An MP3 player or a CD player, on the other hand, is preferably used with a stereo headset with a higher-quality, higher-bandwidth connection.

Both applications are suited to a wireless headset, such as a Bluetooth headset, using a Bluetooth wireless connection to the mobile phone, MP3 player or other audio device.

In the case of the mobile phone headset (telecom headset) the headset can be a relatively simple component. If Bluetooth is used the headset can operate the headset profile, allowing a limited-bandwidth mono two-way audio connection to the mobile phone, which supports the corresponding audio gateway profile. The processing requirements for this application are deliberately restricted allowing an electronic design tailored to that application, for example including the use of a simple Continuously Variable Slope Delta Modulation (CVSD) audio codec.

In the case of the MP3 player, Bluetooth could be used for the connection, but the audio system as a whole has more complex requirements. The wireless link is required to carry stereo audio at higher quality and bandwidth. The above headset profile would be unable to provide the required connection. Several methods could be used to transfer the higher quality audio signal. An MP3 encoded signal can be transferred using for example a file transfer method. The headset would be required to decode the MP3 content, buffering data in RAM as it is received. Alternatively the Bluetooth Audio Video profile and associated codec could be used to stream the audio. Additional processing, memory and audio output circuits would be required, compared to the headset designed for operation with a mobile phone.

Currently, the user would have to operate two complete headset systems for the two applications. This is especially inconvenient where one system could feasibly be used with either a mono telecom headset or a higher quality stereo headset, such as a mobile phone with an MP3 player built in.

Since the architectures required in the two applications are similar, in this invention the telecom headset can be designed to operate both stand alone and as half of a stereo headset when connected to and operated with a second similar or identical unit.

The two headset units can each be designed as a headset device worn next to each ear, either mounted by some kind of ear clip, or connected to a headband. A cable, or other suitable physical connection interconnects the units.

When used alone, the first unit provides a mono telecom headset function, preferably wirelessly connected to the audio device, such as mobile phone. When this unit is coupled, preferably by a cable, to a second headset unit, the two now operate together in a different mode, providing a high quality stereo audio connection to a suitable audio device. The connection between the first and second units is preferably by cable integrated in a head-band provided for stability when both devices are being worn in operational use.

The two units are designed to share the processing, memory, user interface, power management and other operational requirements of the total audio system.

In a first embodiment the two units are designed to have different capabilities, so that the first telecom headset can be used either alone, or with a second unit which cannot be used alone, the latter adding functionality to the first headset unit.

In a second embodiment the two units may be designed to be identical and operable either alone or together. In this case two telecom headsets may used separately as telecom headsets, or connected and operated together to provide a single stereo headset.

In summary, the invention relates to an electronic device comprising a headset with a first unit, preferably integrated with an earpiece. The first unit has a first interface for receiving a first input signal and a processor for processing the first input signal to generate a first audio signal in a first operational mode of the first unit. The first unit has a second interface for receiving a second input signal in a second operational mode, different from the first operational mode, of the headset for generating a second audio signal. For example, in the first operational mode, the first unit has a stand-alone functionality. The first interface of the first unit receives then as the first input signal a Bluetooth signal from a mobile phone, and the processor generates low-bandwidth audio as the first audio signal. In the second operational mode, the second interface receives a high bandwidth signal that is supplied to a transducer of the first unit to provide high-quality audio, e.g., one of the two stereo channels.

Preferably, the headset has a second unit for connecting to the second interface of the first unit. The second unit has a second processor for generating the second input signal, the second operational mode of the first unit involving cooperation with the second unit. For example, the second unit comprises a processor to generate stereo audio from data supplied by an MP3 player and supplies the data or the signal of one stereo channel to the first unit.

The advantages of distributing the functionalities for the two operational modes between the units are the following. At least the first unit or the second unit has a power source and the first and second units can share the power source in the second operational mode. At least the first unit or the second unit has a memory, and the first and second units functionally share the memory in the second operational mode. At least the first or the second unit has a processor, and the first and second units functionally share the processor's processing capability in the second operational mode. At least the first or the second unit has a user interface for enabling a user to control at least the first or the second audio signal, and the first and second units functionally share the user control in the second operational mode.

In an embodiment of the invention, the first unit functions in the first operational mode as an earpiece for a mobile phone. The unit can be equipped with a transceiver for wirelessly communicating with the mobile phone. In the second operational mode, the first unit functions as an earpiece for one channel of stereo audio generated by the second unit.

Accordingly, the second unit can be considered an upgrade of the headset with the first unit. A physical connection between the two forms a headphone for listening to stereo audio. The second unit comprises at least part, or all of, the required processing power, memory and power supply for this stereo audio operational mode. Sharing these resources with one or more resources in the first unit allows for balanced and cost effective design. Distinguishing between the operational modes is enabled, e.g., through detecting whether or not the first and second units are connected, e.g., under control of the second interface of the first unit. For example, a mechanical switch is physically flipped into the required position by the plug of the second unit when inserted into the second interface of the first unit. As another example, upon detecting a voltage or current at the second interface, the first unit is switched to cooperation with the second unit, using a software switch or an electronic switch, etc.

### BRIEF DESCRIPTION OF THE DRAWING

The invention is explained in further detail, by way of example, and with reference to the accompanying drawing, wherein:

FIGS. 1 and 2 are block diagrams of audio devices with headsets;

FIGS. 3 and 4 are block diagrams of components of the audio devices;

FIGS. 5-7 give examples of configurations using the modularity of the devices; and

FIG. 8 is a table illustrating the functional split between the units.

Throughout the figures, same reference numerals indicate similar or corresponding features.

### DETAILED EMBODIMENTS

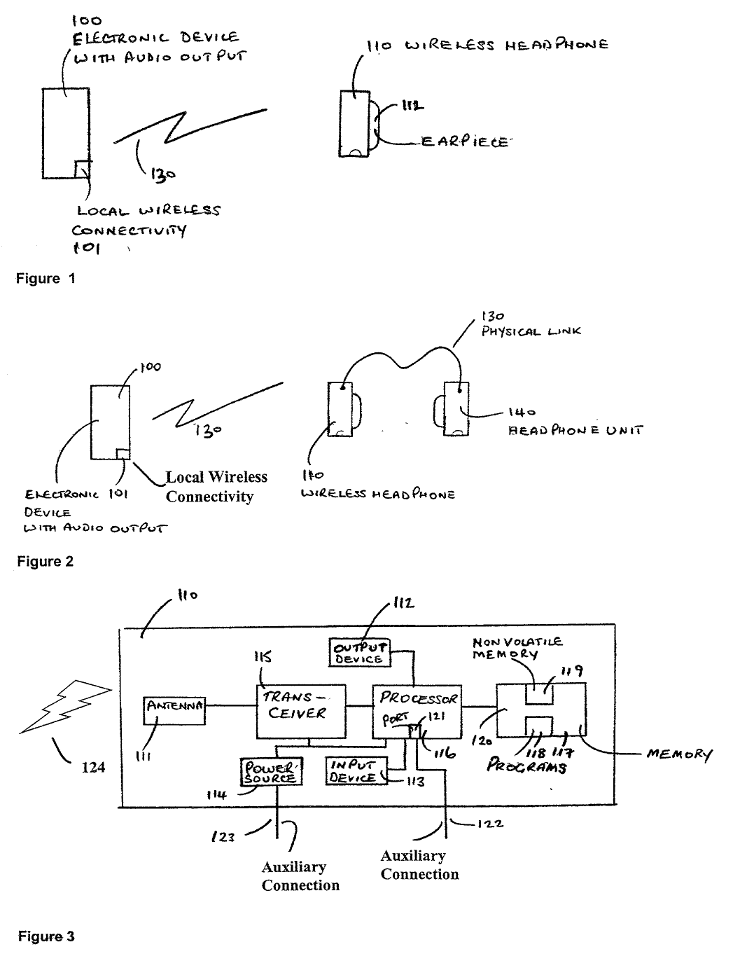

FIG. 1 is a diagram of a wireless headset unit 110 for receiving an audio signal from device 100. Device 100 has an audio output signal. The user receives the audio relayed from device 100, remotely via unit 110, which includes an earpiece audio transducer 112. Device 100 and unit 110 are connected by a wireless link 130, such as a Bluetooth or an IR connection, making use of a local wireless connectivity transceiver 101 accommodated in device 100. An example of such a device 100 is a mobile phone. Wireless headset unit 110 is operated independently and its capabilities are tailored to the required function.

In this primary example of the current state of the art, the user listens to a single earphone, suitable for relaying mono audio from a communications device 100. Typically, headset unit 110 may also include a microphone and a user interface or input device to allow the user to control the unit, such as adjusting the audio volume level.

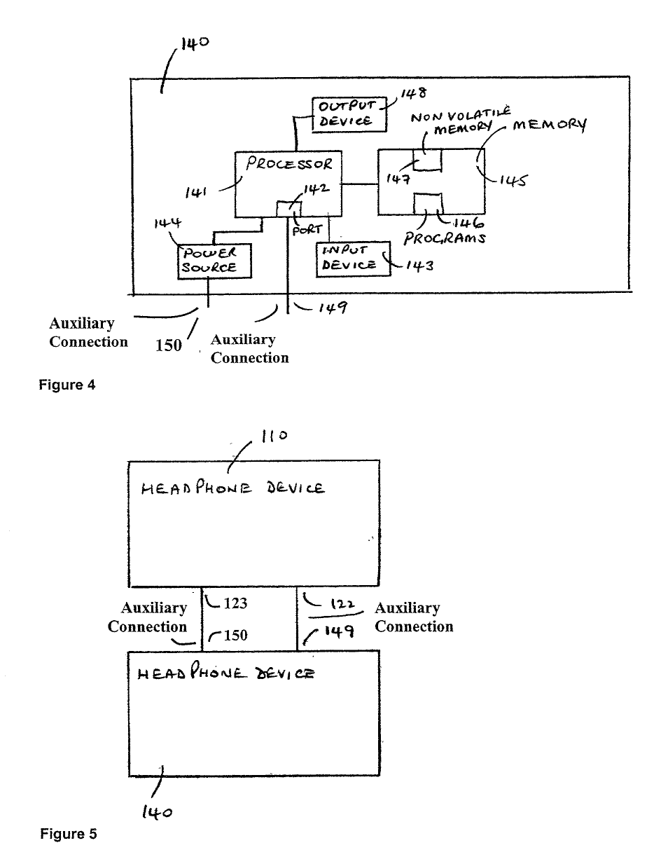

In a preferred embodiment wireless headset unit 110 comprises a Bluetooth headset, providing two-way monoaural wireless communication to device 100, e.g., a mobile phone. Headset unit 110 includes functionality supporting the Bluetooth headset profile, which is optimized for embedded systems requiring a limited sub-set of the full Bluetooth protocol stack, thus limiting the requirements for processing power and program memory. In operation, in this primary function, a typical system can be designed for optimum power efficiency, with the available system resources closely matching the required function. Unit 110, further described in detail below with reference to FIG. 3, is typically battery powered. In the primary operating mode, the user can wear single headset unit 110, clipped to one ear with a built-in microphone and a self contained user interface as described below with reference to FIG. 3. Unit 110 has a memory, software programs, processing power and battery capacity tailored to this function, allowing the best fit to the required functionality and the most cost effective solution to a user requiring such a unit.

In FIG. 2, a second headset unit 140 is connected to first unit 110. The connection is, preferably, a physical connection, such as by a cable 130, i.e., hard-wired. Units 110 and 140 operate together to implement a new function, or a combined device, that offers additional features compared to units 110 or 140 when stand-alone. In this example, unit 140 is different from unit 110 and is designed for operation in conjunction with unit 110. In an alternative example, unit 140 comprises a second unit identical to unit 110, which then also allows a new function, such as a high quality stereo headset to be created from the connection of the two headset units. The user receives, and is able to listen to, the audio relayed from device 100, remotely via headset unit 110. Unit 110 includes an earpiece audio transducer 112. Device 100 and unit 110 are connected by a local wireless connectivity transceiver 101, part of device 100 and wireless link 130, such as a Bluetooth or an IR connection. Examples of device 100 are an MP3 audio player, a CD player, a PC mobile phone with MP3 function. Unit 140 is similar to unit 110 and also includes an earpiece audio transducer as shown for unit 110. Unit 140 may also include a user interface or input component to allow the user to control the unit, such as adjusting the audio volume level. Alternatively, either unit 110 or 140 may provide the functions for the combined system, controlled over physical link 130.

As shown in FIG. 2, wireless unit 110 is connected to second unit 140. The two units 110 and 140 are interconnected physically. Second unit 140 may take the same basic form as first unit 110, so as to form the second unit in a binaural headset designed to be worn directly on the head of the user. Various physical embodiments are possible, e.g., where units 110 and 140 are attached directly to a physical headband, or worn independently directly on the ears. In an alternative embodiment shown in FIG. 7, the usage model for the combined units may be modified from the way a single unit may be used. For example, a headset unit designed for directly mounting via a clip to the ear, may be physically connected to a second unit and worn on the body clipped to a belt, connected to lightweight headphones, worn by the user, when operated in the second mode of operation.

When units 110 and 140 are connected together, the combination has characteristics different to the ones of first unit when used individually. Second unit 140 provides added functionality required by the combination, but which is not wholly provided for in primary unit 110, described in detail below with reference to FIG. 3. An attractive feature of this approach is the ability to reuse first unit 110 by combining it with second unit 140 of similar complexity to the first, in order to create a new, more capable, combined system, without having to obtain a new complete system able to provide the requirements of the second function. These additional requirements of the combined system can be added with the second unit 140.

In a preferred embodiment, the headset is designed to provide a mono wireless headset function in the first mode of operation, and a high quality stereo headset function in the combined secondary mode of operation. The latter requires the addition of a second audio transducer to provide stereo audio reproduction to the user. This allows all the added system functionality in addition to the audio transducer to be provided in second headset unit 140, allowing a novel approach to matching of system complexity to overall usage model. FIGS. 3 and 4 describe headset units suitable for the primary unit 110 and secondary unit 140. The system functionality of the two is very similar in a typical application described, where the overall system complexity is split approximately equally between the two units when operating in the second operational mode. This allows the second unit to match the first in physical size and weight.

FIG. 3 is a block diagram of unit 110 according to the present invention. Unit 110 includes a wireless transceiver 115, connected to an antenna 111 and to a processor 116. Processor 116 controls the operation of unit 110 according to programs 118, stored in a non-volatile memory 119, making further use of a memory 120. Processor 116 is connected to an input device 113, which includes, e.g., a microphone, a keypad or other components that serve to capture inputs from a user. Output device 112 can include any type of output transducer, such as an audio earpiece, in addition to LED indicators, LCD display or another output sub-system. A power source 114 supplies power to unit 110. In a typical embodiment, power source 114 comprises a rechargeable or primary battery. Transceiver 115 connects unit 110 to the source of an audio signal, e.g., device 100, via a wireless link 124. Processor 116 decodes and processes the signal, relaying the output through output device 112 to the user. In addition, processor 116 processes inputs from input device 113, which includes, e.g., a microphone signal relayed via transceiver 115 and link 124 to device 100 to which headset unit 110 is connected. In a preferred embodiment, transceiver 115 comprises a Bluetooth transceiver. Processor 116 then operates the Bluetooth headset profile to allow two-way audio communication to another Bluetooth device 100, such as a mobile phone. Auxiliary connections 123 and 122 allow the processing system, connected via port 121, and power supply of unit 110 to be connected to another device.

FIG. 4 is a block diagram of headset unit 140 according to the present invention. Unit 140 includes a processor 141 for control of the operation of unit 140 according to software programs 146 stored in a non-volatile memory 147, making further use of memory 145. Processor 141 is connected to an input device 143, which includes, e.g., a microphone, a keypad or another devices that can capture inputs from a user. An output device 148 includes any type of output transducer, such as an audio earpiece, and/or LED indicators, an LCD display or another output sub-system. A power source 144 provides power to unit 140. In a typical embodiment, power source comprises a rechargeable or primary battery. Processor 141 decodes and processes signals, relaying the output through output device 148 to the user. Processor 141 relays input and output signals via a port 142 and auxiliary connection 149, which connects unit 140 to another device. In a preferred embodiment, processor 141 may operate an audio decoding system, such as an MP3 player. Such a player receives MP3 encoded signals via connection 149. Data is then buffered in memory 145 as it is received, for decoding into an audio signal, one channel of which is played locally via output device 148, such as an earpiece transducer. The audio signal is also made available (as an analogue or digitally encoded signal) via port 142 and connection 149, for linking to a second system also able to play the now decoded audio signal. In addition, other system control and maintenance signals are routed via connection 149. The power supply may also be connected to another system via a connection 150.

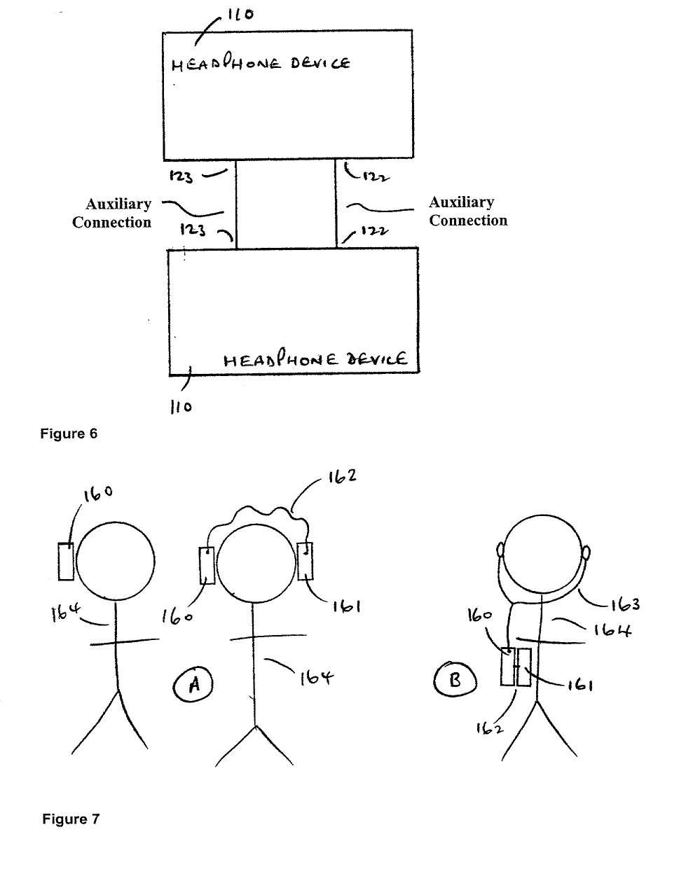

FIG. 5 is a diagram showing how headset units 110 and 140, described above, are interconnected to create a shared system. Auxiliary connections 123 and 144 are linked as are 122 and 149. This allows the power supply and processing system of the two units to be interconnected.

FIG. 6 shows an alternative embodiment of FIG. 5. In FIG. 6 both units are of the same type of unit 110, interconnected to create a shared system. Auxiliary connections 123 and 123 are linked as are 122 and 122 from both units. This allows the power supply and processing system of the two units to be interconnected.

In a preferred embodiment, second unit 140 is different to first unit 110, and is described in FIG. 4. Unit 110 described in FIG. 3 provides wireless connectivity, and audio reproduction of one channel of audio. The audio signal is transferred over the wireless link, and is encoded in a suitable format, which may conform to many alternative standards. In some preferred embodiments, the signal is encoded as MP3, or using the Bluetooth audio/video profile. In either case, first headset unit 110 operates the wireless link, providing an encoded audio signal over the physical link 130 between units 110 and 140. Unit 140 provides additional signal processing, such as MP3 buffering and decoding, as described with reference to FIG. 4. The overall system processing can be split according the available resources, with primary unit 110 providing combined system functions most closely matching its primary function, so that little overhead is added in terms of processing power, memory or other resources beyond that required for the basic operational mode. Secondary unit 140 can further enhance the overall system by providing a second power source 144 which may be shared by the total system.

In a second preferred embodiment, two units are combined which are the same, in this case two wireless headset units, capable of operating independently in the primary mode of operation as described above and with reference to FIG. 3. These can be combined to create a new combined system where each now provides a part of the overall system functionality. Each unit is equipped with appropriate hardware to provide half the combined system function and all the software required to do so. When connected together one takes on operation as master, the other as slave in the combined system. Which unit takes on which role may be pre-configured, selected from the user interface or selected automatically according to a programmed algorithm, such as by each unit comparing the others unique Bluetooth MAC address in a Bluetooth system to its own and making a role selection based on having a higher or lower number than the other device in the system.

In a preferred embodiment, primary unit 110 may have both the software for audio MP3 decode and Bluetooth communication loaded in non volatile memory 119. However the system may be designed so that the processing power is insufficient to handle both operations on one headset unit. In that case, and also for optimum power management, Bluetooth communications is disabled on the second headset unit, which is then able to devote its processing system to audio decoding. Primary unit 110 is devoted primarily to wireless communications.

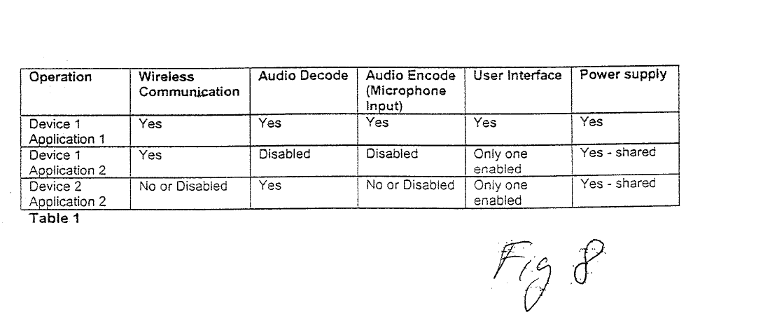

The functional split is summarized in table 1 of FIG. 8, for a preferred application of a dual mode wireless headset system, for either identical paired units or dissimilar paired units.

In a further preferred embodiment, units 110 and 140 may be combined in a system as shown in FIG. 2 and described in detail with reference to FIGS. 3 and 4. n this case it is also possible to combine the units only able to operate in a combined function. For example, a system could be designed optimized to provide a stereo wireless headset system, shared between two units, where neither unit provides a stand alone primary function. If a primary stand-alone function was not required this would could allow the two units to be optimized, e.g., have less memory for the combined function.

FIGS. 7A and 7B show alternative modes of operation. In FIG. 7A, the user 164 is shown wearing a single headset unit 160, e.g., equivalent to unit 110 discussed above. A second unit 161, e.g., equivalent to unit 140 or 110, is added to create secondary functionality in a combined system, connected to the first unit 160 via a link 162. Second unit 161 can be operated in a way similar or identical to that of first unit 160. Units 160 and 161 can be physically similar or identical to form a complete system, such as a stereo headset. However, the addition of a second unit can add both system functionality and allow alternative usage models, as shown in FIG. 7B. In FIG. 7B, first unit 160 has been relocated, such as worn on a belt and is coupled closely to unit 161 via link 162. Unit 160 is now operated with headphones 163 connected to unit 160, to device 161 or to both. Many alternative configurations would be possible.

FIG. 8 is a table summarizing the functional split of a preferred application of a dual mode wireless headset system, for either identical pairs of dissimilar paired units. The table is self-explanatory.

Incorporated herein by reference:

U.S. Ser. No. 09/938,142 (Attorney docket US 018131) filed Aug. 23, 2001 for Eugene Shteyn and Jonathan Griffiths for POWER CACHING PAN ARCHITECTURE. This document relates to a data processing system that has first and second components, which together perform a system functionality. The first and second components each have a respective power source. When the components are attached to each other, the power source of one of the components serves as a charger for the power source of the other component. When detached from each other, the components can communicate wirelessly with one another.

What is claimed is:

1. An electronic device comprising a headset with a first unit that has:
a first interface for receiving a first input signal;
a processor for processing the first input signal to generate a first audio signal in a first operational mode of the first unit;
a second interface for receiving a second input signal in a second operational mode, different from the first operational mode, of the headset for generating a second audio signal.

2. The device of claim 1, wherein the unit in the first operational mode has a stand-alone functionality.

3. The device of claim 1, wherein:
the headset has a second unit for connecting to the second interface;
the second unit has a second processor for generating the second input signal; and
the second operational mode of the first unit involves cooperation with the second unit.

4. The device of claim 3, wherein:
at least the first unit or the second unit has a power source; and
the first and second units share the power source in the second operational mode.

5. The device of claim 3, wherein:
at least the first unit or the second unit has a memory; and
the first and second units functionally share the memory in the second operational mode.

6. The device of claim 3, wherein:
at least the first or the second unit has a processor; and
the first and second units functionally share the processor in the second operational mode.

7. The device of claim 3, wherein
at least the first or the second unit has a user interface for enabling a user to control at least the first or the second audio signal; and
the first and second units functionally share the user control in the second operational mode.

8. The device of claim 2, wherein the first unit functions in the first operational mode as an earpiece for a mobile phone.

9. The device of claim 8, equipped with a transceiver for wirelessly communicating with the mobile phone.

10. The device of claim 3, wherein the first unit functions in the second operational mode as an earpiece for one channel of stereo audio generated by the second unit.

11. The device of claim 3, wherein:
each of the first and second units comprises respective Bluetooth communication components;
each of the first and second units has a respective MAC address; and
when in the second operational mode, a specific one of the first and second units assumes a role of a master and the other unit assumes a role of a slave determined by the respective MAC addresses.

12. A first headset unit comprising:
a first interface for receiving a first input signal;
a processor for processing the first input signal to generate a first audio signal in a first operational mode of the first unit;
a second interface for receiving a second input signal in a second operational mode, different from the first operational mode, of the headset for generating a second audio signal.

13. The first headset unit of claim 12, comprising a transceiver for wirelessly communicating with a mobile phone.

14. The first headset unit of claim 12, operative to switch between the operational modes under control of the second interface.

15. A second headset unit for upon connection to an interface of a first headset unit sharing a resource of the second headset unit.

16. The second headset unit of claim 15, comprising a stereo audio processor.
